(19) United States
(12) Patent Application Publication
(10) Pub. No.: US 2023/0163543 A1
(43) Pub. Date: May 25, 2023

(54) Replaceable Socket Device and Adapter

(71) Applicant: ENERGY FULL ELECTRONICS CO., LTD., New Taipei City (TW)

(72) Inventor: Hsu-Shen CHIN, New Taipei City (TW)

(21) Appl. No.: 17/866,515

(22) Filed: Jul. 17, 2022

Related U.S. Application Data
(60) Provisional application No. 63/281,784, filed on Nov. 22, 2021.

(51) Int. Cl. H01R 31/06; H01R 24/78; H01R 13/70

(52) U.S. Cl. CPC H01R 31/065; H01R 24/78; H01R 13/70

(57) ABSTRACT

The embodiments of the present disclosure are directed to a replaceable socket device and an adapter. The replaceable socket device includes at least one adapting element and an adapter. Each of the at least one adapting elements includes a first polarity terminal, a second polarity terminal, and a third polarity terminal. The adapter includes at least one adapter interface, a first polarity adapting member, a second polarity adapting member, and a third polarity adapting member. When the at least one adapting element and the at least one adapter interface are engaged with each other, the at least one adapting element is electrically connected to the at least one adapter interface.

### CROSS REFERENCE TO RELATED APPLICATION

This application claims priority to U.S. provisional Application No. 63/281,784, filed on Nov. 22, 2021. The entire disclosure of the above application is incorporated herein by reference.

### FIELD OF THE INVENTION

The present disclosure relates to a replaceable socket device and an adapter, more particularly, to a modular replaceable socket device and an adapter which are suitable for various interfaces.

### BACKGROUND

The sockets for domestic and commercial electricity are generally categorized into types utilized in 110-120V or 220-240V. The 110V-120V socket is further divided into a two-hole type and a three-hole type. Therefore, the type of the sockets has to be chosen in advance before installing or purchasing sockets. For example, the three-hole type sockets utilized to 220-240V should be installed nearby where the air-conditioner will be set, and the two-hope type or the three-hole type sockets utilized in 110-120V should be installed nearby where the electronic appliances will be set. In addition, not only should the voltage should be considered, the types of sockets should be noted as well in case, for example, the three-pin plug will not fit the two-hole sockets. Furthermore, the plugs have to be inserted in specific direction, in this situation, the power cable will be curved and the insulation layer of the power cable may rupture, resulting in leakage of electricity or a short circuit.

The electronic appliances which are purchased overseas cannot be used anymore since the sockets do not fit the plugs. Although there are adapters available on the markets, however, it's inconvenient to attach an adapter on the plug, and occupy more space and sometimes cause danger due to the low-quality of the adapters.

Generally speaking, the household alternating current (AC) power line has a polarity, and the general power socket has a power protection switch, which is usually set on a charged electrode. Therefore, whether it is a commercially available adapter or an external transformer, to ensure the normal operation of the power protection switch, it is necessary to ensure that the polarity of the socket is consistent with the adapter. For example, the general socket usually takes a wide contact as the neutral line to avoid affecting the safety of power consumption. When in use, the socket and the inserting hole need to be in the same direction, so the socket can be inserted. However, if the position of the electrical appliance cannot be changed, the power line needs to be bent to match the direction of the socket. In this way, it is easy to damage the insulation layer of the power line, thereby causing electric leakage or short circuit easily.

Furthermore, the Power Line Communication (PLC) technologies allow the network data to be transmitted by the power cables. The PLC technologies requires modems installed on sockets or network bridge with PLC functions, however it's inconvenient to attach an adapter on the plug, and occupy more space as well.

### SUMMARY

To solve the above problem, the present disclosure provides a modular replaceable socket device and an adapter. The replaceable socket device is capable of selecting the required adapting element and installing it on the adapter according to the different requirements of specification and type. In addition, the adapting element and the adapter of the present disclosure respectively have a fool-proofing structure, which is helpful to improve the user experience and power safety. Furthermore, the adapting element can adjust the direction according to the position and the space of the electrical appliance while ensuring the safety of power consumption, and a safety device can also be added to the replaceable socket device, which can not only save the trouble of using additional adapter or external transformer but also have beauty and safety at the same time.

According to a first aspect of the present disclosure, a replaceable socket device includes at least one adapting element and an adapter. Each of the at least one adapting element comprises a first polarity terminal having a first polarity, a second polarity terminal having a second polarity, and a third polarity terminal having a third polarity. The adapter comprises at least one adapter interface, a first polarity adapting member, a second polarity adapting member, and a third polarity adapting member. The adapter interface is used to engage with the at least one adapting element, and at least one first polarity interface, at least one second polarity interface, and a third polarity interface are disposed in each of the at least one adapter interface. The first polarity adapting member is electrically connected to the at least one first polarity interface. The second polarity adapting member is electrically connected to the at least one second polarity interface. The third polarity adapting member is electrically connected to the third polarity interface. When the at least one adapting element and the at least one adapter interface are engaged with each other, the first polarity terminal is electrically connected to the at least one first polarity interface, the second polarity terminal is electrically connected to the at least one second polarity interface, and the third polarity terminal is electrically connected to the third polarity interface.

According to a second aspect of the present disclosure, an adapter adapted to at least one replaceable adapting element, includes at least one adapter interface, a first polarity adapting member, a second polarity adapting member, and a third polarity adapting member. The at least one adapter interface is engaged with the at least one adapting element. Each of the at least one adapter interface includes a first polarity interface, a second polarity interface, and a third polarity interface. The first polarity adapting member is electrically connected to the at least one first polarity interface. The second polarity adapting member is electrically connected to the at least one second polarity interface. The third polarity adapting member is electrically connected to the third polarity interface. When the at least one adapting element and the at least one adapter interface are engaged with each other, the at least one adapting element is electrically connected to the at least one adapter interface.

Compared with the prior art, the replaceable socket device and the adapter of the present disclosure can replace the adapting element according to the requirement, or change the installation direction according to the use situation. In addition, the adapter can also have different shapes for a user to choose from. The detachable adapter cable of the cable interface can also be pulled out when not in use, which facilitates the overall storage of the replaceable socket device and reduces the occupation of space. Furthermore, due to the assemblies being modular, the user can select only the needed part or choose to purchase only the damaged part, so that the cost can be reduced during manufacturing, and the user can also reduce the cost during purchase. Therefore, the replaceable socket device and the adapter of the present disclosure have the advantages of power safety, beauty, space-saving, and cost-effectiveness.

### BRIEF DESCRIPTION OF THE DRAWINGS

To describe the technical solutions in the embodiments of this application more clearly, the following briefly introduces the accompanying drawings required for describing the embodiments. Apparently, the accompanying drawings in the following description show merely some embodiments of this application, and a person of ordinary skill in the art may still derive other drawings from these accompanying drawings without creative efforts.

FIGS. 1 to 4 are schematic diagrams of a replaceable socket device according to one embodiment of the present disclosure.

FIG. 5 is a three-dimensional schematic diagram of a perspective of an adapting element and an adapter according to first embodiment of the present disclosure.

FIG. 6 is a three-dimensional schematic diagram of another perspective of the adapting element and the adapter according to first embodiment of the present disclosure.

FIG. 7 is a three-dimensional schematic diagram of a perspective of an adapting element and an adapter according to second embodiment of the present disclosure.

FIG. 8 is a three-dimensional schematic diagram of another perspective of the adapting element and the adapter according to second embodiment of the present disclosure.

FIG. 9 is a three-dimensional schematic diagram of a perspective of an adapting element and an adapter according to third embodiment of the present disclosure.

FIG. 10 is a three-dimensional schematic diagram of another perspective of the adapting element and the adapter according to third embodiment of the present disclosure.

FIG. 11 is a three-dimensional schematic diagram of a perspective of an adapting element and an adapter according to fourth embodiment of the present disclosure.

FIG. 12 is a three-dimensional schematic diagram of another perspective of the adapting element and the adapter according to fourth embodiment of the present disclosure.

FIG. 13 is a three-dimensional schematic diagram of a first fool-proofing structure of the adapting element and a second fool-proofing structure of the adapter according to first embodiment of the present disclosure.

FIG. 14 is a three-dimensional schematic diagram of a first fool-proofing structure of the adapting element and a second fool-proofing structure of the adapter according to second embodiment of the present disclosure.

FIG. 15 is a three-dimensional schematic diagram of a first fool-proofing structure of the adapting element and a second fool-proofing structure of the adapter according to third embodiment of the present disclosure.

FIG. 16 is a three-dimensional schematic diagram of a first fool-proofing structure of the adapting element and a second fool-proofing structure of the adapter according to fourth embodiment of the present disclosure.

FIG. 17 is a three-dimensional schematic diagram of a first fool-proofing structure of the adapting element and a second fool-proofing structure of the adapter according to fifth embodiment of the present disclosure.

FIG. 18 is a top view of a power socket of the replaceable socket device according to one embodiment of the present disclosure.

FIG. 19 is a top view of a female interface of the replaceable socket device according to one embodiment of the present disclosure.

### DESCRIPTION OF THE EMBODIMENTS

In order to facilitate understanding the technical features, content and advantages of the invention and the efficacy it can achieve, the present disclosure is hereby combined with the accompanying drawings, and the expression of the embodiment is described in detail as follows, and the scheme used therein, the main purpose of which is only for illustrative and auxiliary explanation purposes, may not be the true proportion and precise configuration of the embodiment of the present disclosure, so the proportion and configuration relationship of the attached drawing should not be interpreted, limiting the scope of rights of the invention in the actual implementation.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

The following will refer to the relevant drawings, illustrating various embodiments of the replaceable socket device according to the present disclosure, for ease of understanding, the same components in the following embodiments are illustrated by the same symbols.

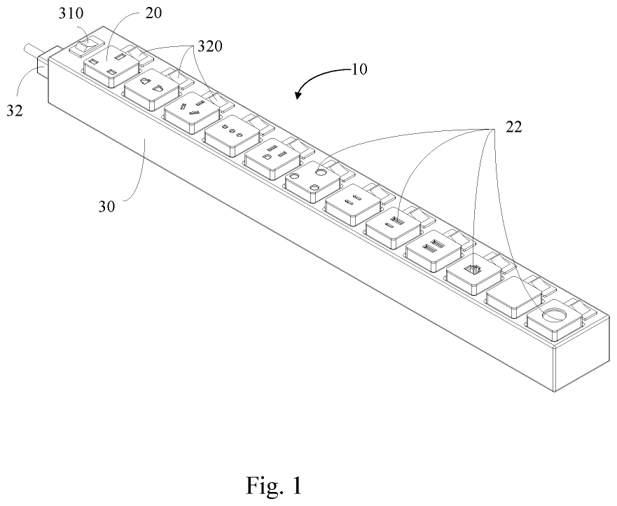

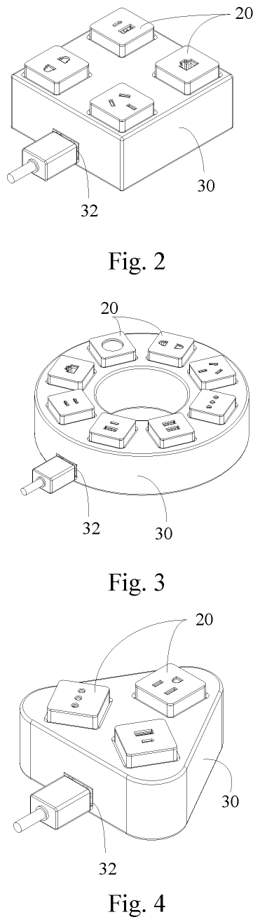

Please refer to FIGS. 1 to 4, FIGS. 1 to 4 are schematic diagrams of a replaceable socket device 10 according to one embodiment of the present disclosure. The replaceable socket device 10 comprises at least one adapting element 20, an adapter 30, and a cable interface 32. In other embodiments, the adapting element 20 can also be multiple. In addition, the replaceable socket device 10 and its assemblies can also be modular, thereby replacing easily. The cable interface 32 can be electrically connected to the socket of the indoor power supply to receive the AC of the indoor power supply. The cable interface 32 may be a detachable cable interface, which can be separated from the adapter 30 when it is not in use. The other end of the cable interface 32 may be a power plug of general electric supply 110 V to 120 V or 220 V to 240 V, or a power plug conforming to different specifications, such as type A power plug, type B power plug, type C power plug, type D power plug, type E power plug, type F power plug, type G power plug, type H power plug, type I power plug, type J power plug, type K power plug, and type L power plug. The adapter 30 can have different shapes. As shown in FIGS. 2 to 4, the adapter 30 may be shaped as a common long strip, or a square, a ring, a triangle, and other shapes. While the adapter assemblies 20 located on the adapter 30 can be a matrix arrangement in the same direction as shown in FIG. 2, or a circular permutation in different directions as shown in FIGS. 3 and 4. The shape of the adapter 30 and the arrangement of the adapter assemblies 20 in FIGS. 2 to 4 are only examples and are not used to limit the present disclosure. Any of the shape of adapter 30 and the arrangement of adapter assemblies 20 (such as the array arrangement of adapter assemblies on a triangular adapter) are within the scope of the present disclosure.

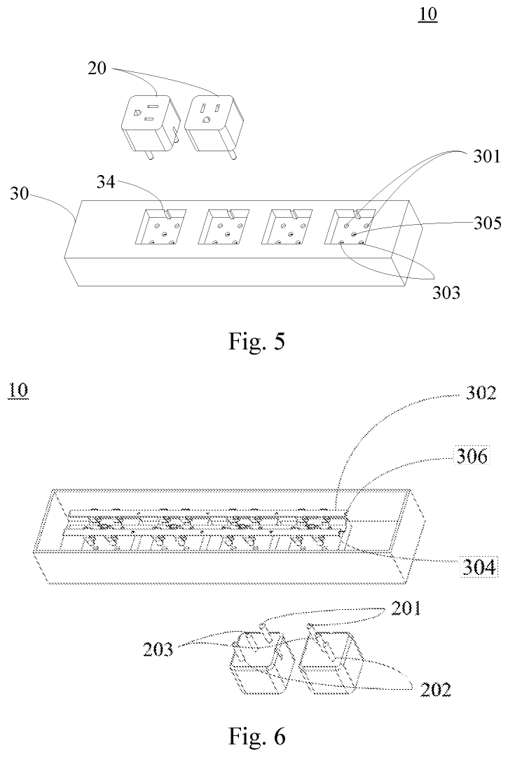

In addition, the adapter 30 can have one or more switches. As shown in FIGS. 1 and 5, the adapter 30 comprises at least one adapter interface 34 and a switch 320 arranged next to and pair with each of the at least one adapter interface 34 to control whether the power supply of the adapter interface 34 is turned on. In one embodiment, the adapter interface 34 may be a socket, a recessed storage space, or other adapter interface suitable for engagement with the adapting element 20, and the present disclosure is not limited thereto. The adapter 30 may also be arranged with a main switch 310 to control whether the power supply of all adapter interfaces 34 on the adapter 30 is turned on. The main switch 310 and the sub switch 320 can be set with a load control. When the load is exceeded, it will automatically switch off and turn it into an open circuit.

### The Embodiments of an Adapting Element and an Adapter

In the following description, for ease of understanding, the icons in the following embodiments, such as the cable interface 32, the main switch 310, and the sub switch 320 are omitted. Please refer to FIGS. 1, 5, and 6 together. FIG. 5 is a three-dimensional schematic diagram of a perspective of an adapting element 20 and an adapter 30 according to first embodiment of the present disclosure. FIG. 6 is a three-dimensional schematic diagram of another perspective of the adapting element 20 and the adapter 30 according to first embodiment of the present disclosure. In the first embodiment, one top surface of the adapting element 20 of the replaceable socket device 10 of the present disclosure is provided with a female interface 22, which can be inserted by the plug of an electronic device to obtain power supply. The adapting element 20 comprises a first polarity terminal 201, a second polarity terminal 202, and a third polarity terminal 203. The first polarity terminal 201 has a first polarity, the second polarity terminal 202 has a second polarity, and the third polarity terminal 203 has a third polarity. The adapter 30 comprises the at least one adapter interface 34 and at least one first polarity interface 301, at least one second polarity interface 303, and a third polarity interface 305, which are disposed in the at least one adapter interface 34. The at least one adapter interface 34 is used to engage with the at least one adapting element 20. When the at least one adapter 34 and the at least one adapting element 20 are engaged with each other, the at least one adapting element 20 is electrically connected to the at least one adapter 34. The at least one first polarity interface 301 corresponds to the first polarity terminal 201 and has the first polarity, the at least one second polarity interface 303 corresponds to the second polarity terminal 202 and has the second polarity, and the third polarity interface 305 corresponds to the third polarity terminal 203 and has the third polarity. In one embodiment, the number of the at least one adapter interface 34 is a plural number, and the number of the at least one first polarity interface 301 and the at least one second polarity interface 303 are respectively two, but the present disclosure is not limited thereto.

The adapter 30 further comprises a first polarity adapting member 302, a second polarity adapting member 304, and a third polarity adapting member 306. The first polarity adapting member 302 is electrically connected to the at least one first polarity interface 301, the second polarity adapting member 304 is electrically connected to the at least one second polarity interface 303, and the third polarity adapting member 306 is electrically connected to the third polarity interface 305. When the at least one adapting element 20 and the at least one adapter interface 34 are engaged with each other, the first polarity terminal 201 is electrically connected to the at least one first polarity interface 301, the second polarity terminal 202 is electrically connected to the at least one second polarity interface 303, and the third polarity terminal 203 is electrically connected to the at least one third polarity interface 305. That is, while in use, when the plug of the electronic device is inserted into the female interface 22, and then the adapting element 20 is inserted into the adapter interface 34, so that the first polarity terminal 201, the second polarity terminal 202, and the third polarity terminal 203 are in contact with the first polarity adapting member 302, the second polarity adapting member 304, and the third polarity adapting member 306, respectively. The electronic device is electrically connected to the first polarity adapting member 302 through the at least one first polarity interface 301 through the first polarity terminal 201 of the adapting element 20, the second polarity adapting member 304 through the at least one second polarity interface 303 through the second polarity terminal 202 of the adapting element 20, and the third polarity adapting member 306 through the at least one third polarity interface 305 through the third polarity terminal 203 of the adapting element 20, respectively. The cable interface 32 of the adapter 30 is electrically connected to the phase line (also known as fire wire or live wire), neutral line, and ground line of the electric supply, respectively, to provide AC.

The electric potentials of the first polarity terminal 201, the second polarity terminal 202, and the third polarity terminal 203 are different from those of the first polarity adapting member 302, the second polarity adapting member 304, and the third polarity adapting member 306, and can generally be divided into phase line, neutral line, and ground line. In one embodiment, the first polarity adapting member 302 and the second polarity adapting member 304 can have a first potential or a second potential respectively corresponding to the phase line or the neutral line, while the third polarity adapting member 306 can correspond to the ground line and have a third potential. However, the present disclosure is not limited thereto. As long as the design can ensure that the polarity of each of the polarity terminals in the adapting element 20 is consistent with that of each of the polarity adapting members of the adapter 30 electrically connected.

As shown in FIGS. 5 and 6, the adapting element 20 may be installed into the adapter interface 34 on the adapter 30 in a first installation direction or a second installation direction. For example, installing in the first installation direction (an X direction) is to set the adapting element 20 perpendicular to the X direction, while installing in the second installation direction (a Y direction) is to set the adapting element 20 parallel to the X direction. The first installation direction and the second installation direction are perpendicular to each other, so as to ensure that the adapting element 20 is installed in either the first installation direction or the second installation direction, the polarity of each of the polarity terminals in the adapting element 20 is consistent with that of each of the polarity adapting members of the adapter 30 electrically connected, thereby ensuring the normal operation of the power protection switch and increasing the safety of power consumption.

The first polarity terminal 201, the third polarity terminal 203, and the second polarity terminal 202 are sequentially arranged diagonally on a bottom surface opposite to the female interface 22 on the adapting element 20, and can be arranged equidistant from each other. In addition, the first polarity terminal 201, the second polarity terminal 202, and the third polarity terminal 203 are respectively cylindrical and have the same shape as each other. The at least one first polarity interface 301, the at least one second polarity interface 303, and the third polarity interface 305 of the adapter 30 can be respectively arranged corresponding to the first polarity terminal 201, the second polarity terminal 202, and the third polarity terminal 203, and be grooves or slots capable of holding their cylindrical shape, but the present disclosure is not limited thereto. In addition, the at least one first polarity interface 301 and the at least one second polarity interface 303 are also arranged diagonally to each other. That is, as shown in FIG. 5, when the number of the first polarity interface 301 and the second polarity interface 303 is respectively two, the first polarity interface 301 and the second polarity interface 303 can present in an “X” shape, and the third polarity interface 305 is disposed at the intersection of diagonal lines.

As shown in FIGS. 5 and 6, the first polarity adapting member 302 and the second polarity adapting member 304 are arranged to be lower than the third polarity adapting member 306 in a Z direction (vertical direction) and parallel to each other, so as to avoid short circuit caused by contact between the every polarity adapting members, thereby improving power safety. In addition, the first polarity adapting member 302, the second polarity adapting member 304, and the third polarity adapting member 306 are disposed of a plurality of U-shaped receiving portions (not labeled in the figures) to respectively fit the shape of the first polarity terminal 201, the second polarity terminal 202, and the third polarity terminal 203, so that the every polarity terminals can be engaged with the every polarity adapting members more stable.

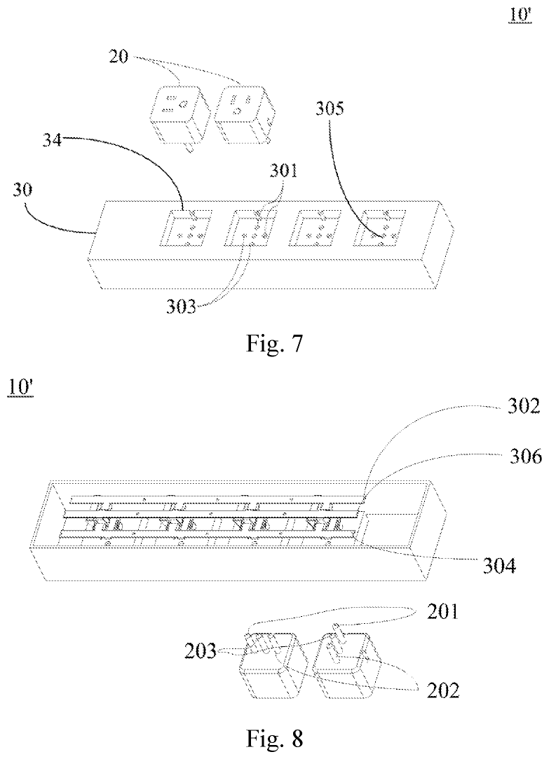

Please refer to FIGS. 7 and 8. FIG. 7 is a three-dimensional schematic diagram of a perspective of an adapting element 20 and an adapter 30 according to second embodiment of the present disclosure. FIG. 8 is a three-dimensional schematic diagram of another perspective of the adapting element 20 and the adapter 30 according to second embodiment of the present disclosure. The second embodiment of the present disclosure is directed to a replaceable socket device 10′, which is different from the replaceable socket device 10 of the first embodiment at least in that the first polarity terminal 201, the second polarity terminal 202, and the third polarity terminal 203 are disposed in a straight line (perpendicular or parallel to the X direction in the first installation direction), and the at least one first polarity interface 301, the at least one second polarity interface 303, and the third polarity interface 305 may be disposed in a cross shape corresponding to the first polarity terminal 201, the second polarity terminal 202, and the third polarity terminal 203, respectively.

As shown in FIGS. 7 and 8, in the second embodiment, the first polarity adapting member 302 and the second polarity adapting member 304 are arranged to be higher than the third polarity adapting member 306 in the Z direction (vertical direction), and are in a special shape in coordination with the cross shape of the first polarity interface 301 and the second polarity interface 303, so as to avoid short circuit caused by contact between the every polarity adapters. Other technical features of the adapting element 20 and the adapter 30 of the second embodiment have been described in the first embodiment, so they will not be repeated here.

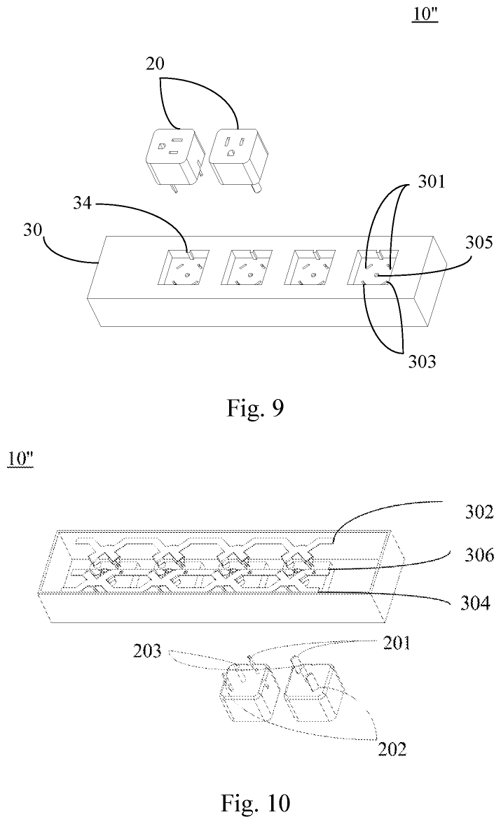

Please refer to FIGS. 9 and 10. FIG. 9 is a three-dimensional schematic diagram of a perspective of an adapting element 20 and an adapter 30 according to third embodiment of the present disclosure. FIG. 10 is a three-dimensional schematic diagram of another perspective of the adapting element 20 and the adapter 30 according to third embodiment of the present disclosure. The third embodiment of the present disclosure is directed to a replaceable socket device 10″, which is different from the replaceable socket device 10 of the first embodiment at least in that the first polarity terminal 201 and the second polarity terminal 202 are respectively rectangular columnar, and the shapes are the same as each other, while the third polarity terminal 203 is cylindrical. The at least one first polarity interface 301 and the at least one second polarity interface 303 of the adapter 30 are grooves or slots capable of holding a rectangular cylindrical shape, but the present disclosure is not limited thereto.

As shown in FIGS. 9 and 10, in the third embodiment, the first polarity adapting member 302 and the second polarity adapting member 304 are arranged to be lower than the third polarity adapter 306 in the Z direction (vertical direction), and are in a special shape in coordination with the “X” shape setting of the first polarity interface 301 and the second polarity interface 303, so as to avoid short circuit caused by contact between the every polarity adapters. Other technical features of the adapting element 20 and the adapter 30 of the third embodiment have been described in the first embodiment, so they will not be repeated here.

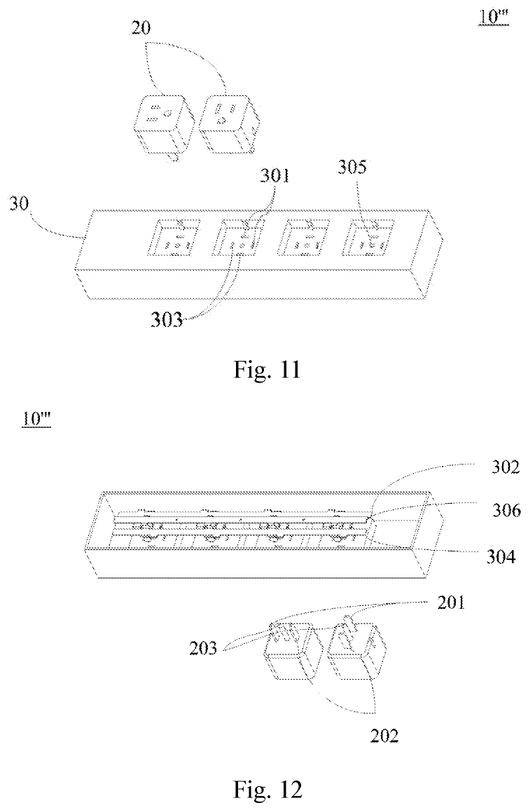

Please refer to FIGS. 11 and 12. FIG. 11 is a three-dimensional schematic diagram of a perspective of an adapting element 20 and an adapter 30 according to fourth embodiment of the present disclosure. FIG. 12 is a three-dimensional schematic diagram of another perspective of the adapting element 20 and the adapter 30 according to fourth embodiment of the present disclosure. The fourth embodiment of the present disclosure is directed to a replaceable socket device 10′″. The replaceable socket device 10′″ of the fourth embodiment is different from the replaceable socket device 10 of the first embodiment at least in that the first polarity terminal 201 and the second polarity terminal 202 are respectively rectangular columnar, and the shapes are the same as each other, while the third polarity terminal 203 is cylindrical. The at least one first polarity interface 301 and at least one second polarity interface 303 of the adapter 30 are grooves or slots capable of holding a rectangular cylindrical shape, but the present disclosure is not limited thereto. The at least one first polarity interface 301, the at least one second polarity interface 303, and the third polarity interface 305 of the adapter 30 may be disposed in a cross shape corresponding to the first polarity terminal 201, the second polarity terminal 202, and the third polarity terminal 203, respectively.

As shown in FIGS. 11 and 12, in the fourth embodiment, the first polarity adapting member 302 and the second polarity adapting member 304 are arranged to be higher than the third polarity adapting member 306 in the Z direction (vertical direction), and are in a special shape in coordination with the cross shape of the first polarity interface 301 and the second polarity interface 303, so as to avoid short circuit caused by contact between the every polarity adapters. Other technical features of the adapting element 20 and the adapter 30 of the fourth embodiment have been described in the first embodiment, so they will not be repeated here.

In particular, the shapes of the above polarity terminals, polarity interfaces, and polarity adapting members of the present disclosure are only examples, which can also be oval, triangular, or other shapes, and can be configured according to actual needs. The present disclosure is not limited to specific shapes and setting methods.

### The Embodiments of a Fool-Proof Structure

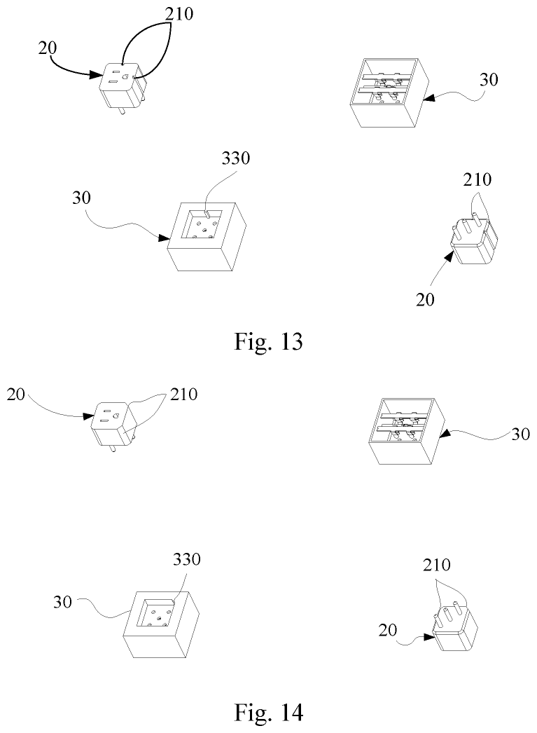

In the following description, for ease of understanding, the icons in the following embodiments, such as the cable interface 32, the main switch 310, and the sub switch 320 are omitted, and the adapting element 20 and the adapter interface 34 are only illustrated in one group. The at least one adapting element 20 of the replaceable socket device 10, 10′, 10″, 10′″ of the present disclosure further comprises at least one first fool-proofing structure 210. The adapter 30 of the present disclosure further comprises at least one second fool-proofing structure 330, which is respectively disposed in the at least one adapter interface 34, and the at least one second fool-proofing structure 330 is adapted to the at least one first fool-proofing structure 210. As mentioned above, in order to make the polarity consistent, the adapting element 20 of the present disclosure can be installed in the first installation direction or the second installation direction. Please refer to FIGS. 5, 6, and 13. FIG. 13 is a three-dimensional schematic diagram of a first fool-proofing structure 210 of the adapting element 20 and a second fool-proofing structure 330 of the adapter 30 according to first embodiment of the present disclosure. As shown in FIG. 13, the at least one first fool-proofing structure 210 is a groove, and the at least one second fool-proofing structure 330 is a protrusion structure adapted to the groove. For example, the top surface of the adapting element 20 as a rectangle, the first fool-proofing structure 210 may be two grooves respectively arranged on both adjacent sides of the adapting element 20, while the second fool-proofing structure 330 may be a protrusion structure arranged in the adapter interface 34 (e. g., one side). Alternatively, in another embodiment, the first fool-proofing structure 210 may be two protrusion structures respectively arranged on both adjacent sides of the adapting element 20, while the second fool-proofing structure 330 may be a groove arranged in the adapter interface 34. The present disclosure is not limited to the shape of the protrusion structure and the groove.

Please refer to FIG. 14, which is a three-dimensional schematic diagram of a first fool-proofing structure 210 of the adapting element 20 and a second fool-proofing structure 330 of the adapter 30 according to second embodiment of the present disclosure. The at least one first fool-proofing structure 210 is at least one lead angle, and the at least one second fool-proofing structure 330 is at least one concave structure adapted to the at least one lead angle. For example, the top surface of the adapting element 20 as a rectangle, for example, the first fool-proofing structure 210 can be two lead angles formed at two adjacent corners of the adapting element 20, while the second fool-proofing structure 330 can be a concave structure arranged in the adapter interface 34 (e. g., one corner). The present disclosure is not limited to the shape or angle of the concave structure and the lead angle.

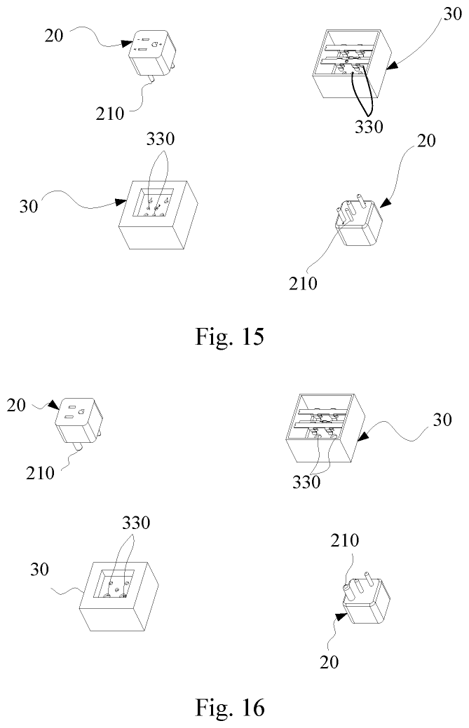

Please refer to FIG. 15, which is a three-dimensional schematic diagram of a first fool-proofing structure 210 of the adapting element 20 and a second fool-proofing structure 330 of the adapter 30 according to third embodiment of the present disclosure. The at least one first fool-proofing structure 210 is at least one columnar structure, and the at least one second fool-proofing structure 330 is at least one containing structure adapted to the at least one columnar structure. For example, the first fool-proofing structure 210 may be a columnar structure protruding on the bottom surface of the adapting element 20 relative to the female interface 22, while the second fool-proofing structure 330 may be two containing structures arranged on one surface of the adapter interface 34 (e.g., the adapter interface 34 is provided with one surface of the first polarity interface 301, the second polarity interface 303, and the third polarity interface 305). Alternatively, in another embodiment, the first fool-proofing structure 210 may be a containing structure arranged on the bottom surface of the adapting element 20 relative to the female interface 22, while the second fool-proofing structure 330 may be two columnar structures protruding on one surface of the adapter interface 34. The present disclosure is not limited to the shape of the columnar structure and the containing structure.

Please refer to FIG. 16, which is a three-dimensional schematic diagram of a first fool-proofing structure 210 of the adapting element 20 and a second fool-proofing structure 330 of the adapter 30 according to fourth embodiment of the present disclosure. A size of the first polarity terminal 201 is larger than that of the second polarity terminal 202. The first polarity terminal 201 is used as the at least one first fool-proofing structure 210, and the at least one second fool-proofing structure 330 is the at least one containing structure adapted to the first polarity terminal 201. That is, in the fourth embodiment, the adapting element 20 and the adapter 30 do not need to be respectively provided with the first fool-proofing structure 210 and the second fool-proofing structure 330, but adjust the size of the first polarity terminal 201 and the corresponding first polarity interface 301 (e.g., adjust its cylindrical volume), so that the first polarity terminal 201 cannot be inserted into the second polarity interface 303, to use it as the first fool-proofing structure 210 and the second fool-proofing structure 330, thereby reducing the production cost, reducing steps, and improving yield rate. In another embodiment, the size of the second polarity terminal 202 may be larger than the first polarity terminal 201, the second polarity terminal 202 is used as the at least one first fool-proofing structure 210, and the at least one second fool-proofing structure 330 is at least one containing structure adapted to the second polarity terminal 202. However, the present disclosure is not limited thereto.

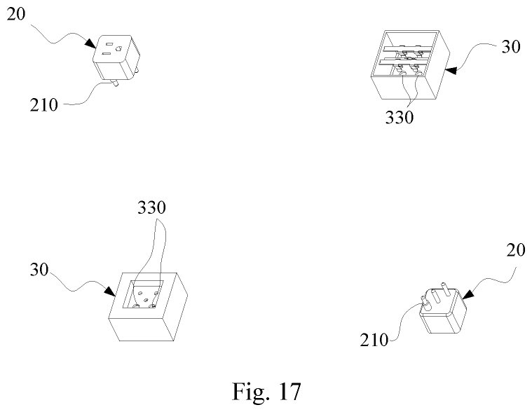

Please refer to FIG. 17, which is a three-dimensional schematic diagram of a first fool-proofing structure 210 of the adapting element 20 and a second fool-proofing structure 330 of the adapter 30 according to fifth embodiment of the present disclosure. The first polarity terminal 201 comprises a sleeve structure, a part of which is sleevedly disposed on the first polarity terminal 201, so that the size of one end (or bottom end) of the first polarity terminal 201 close to the bottom surface of the adapting element 20 is greater than that of the second polarity terminal 202, and the size of one end (or tip) away from the bottom surface of the adapting element 20 is equal to that of the second polarity terminal 202, so that the first polarity terminal 201 is used as the at least one first fool-proofing structure 210, and the at least one second fool-proofing structure 330 is at least one containing structure adapted to the first polarity terminal 201. That is, in the fifth embodiment, the adapting element 20 and the adapter base do not need to be respectively provided with the first fool-proofing structure 210 and the second fool-proofing structure 330, but adjust the sleeve structure (the size of part of the cylindrical volume) partially sleeved on the bottom end of the first polarity terminal 201 and the corresponding first polarity interface 301, so that the first polarity terminal 201 cannot be completely inserted into the second polarity interface 303, to use it as the first fool-proofing structure 210 and the second fool-proofing structure 330, thereby reducing the production cost, reducing steps, and improving yield rate. In another embodiment, the second polarity terminal 202 may also comprises a sleeve structure, a part of which is sleevedly disposed on the first polarity terminal 201, so that the second polarity terminal 202 is used as the at least one first fool-proofing structure 210, and the at least one second fool-proofing structure 330 is at least one containing structure adapted to the second polarity terminal 202. However, the present disclosure is not limited thereto.

Thus, through the first fool-proofing structure 210 and the second fool-proofing structures 330 matched with each other, the adapting element 20 can be limited to be installed on the adapter 30 only in the first installation direction or the second installation direction, and the user can directly see how the adapting element 20 should be installed visually, so as to avoid the user's wrong insertion when using the replaceable socket device 10, 10′, 10″, 10′″, and reduce the risk of short circuit or electric leakage.

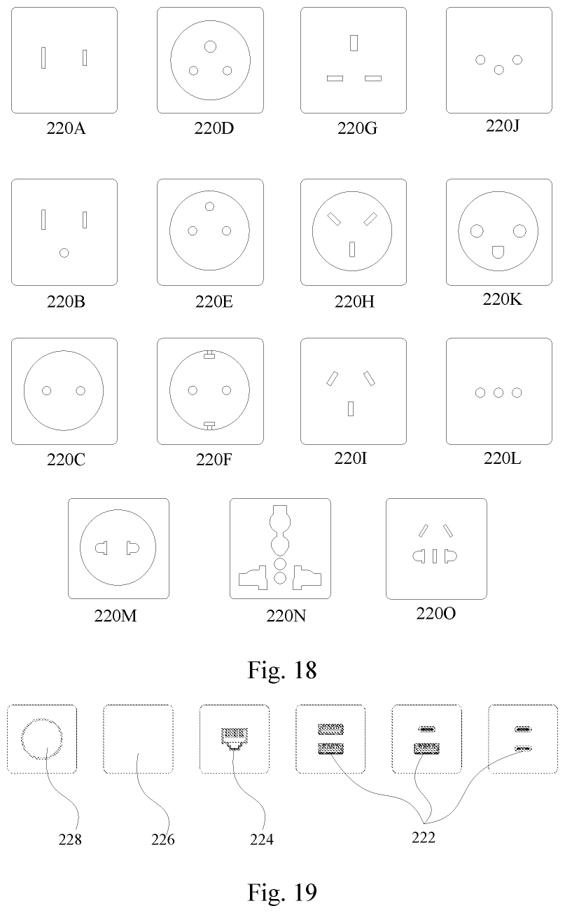

In addition, please refer to FIGS. 1, 5, and 18, FIG. 18 is a top view of a power socket of the replaceable socket device according to one embodiment of the present disclosure. The female interface 22 arranged on the top surface of the adapting element 20 of the replaceable socket device 10 can be the power socket 220 of general electric supply 110 V to 120 V or 220 V to 240 V, and the power socket 220 can also be a power socket of different specifications. As shown in FIG. 18, the female interface 22 can be a power socket conforming to different specifications, such as type A power socket 220A, type B power socket 220B, type C power socket 220C, type D power socket 220D, type E power socket 220E, type F power socket 220F, type G power socket 220G, type H power socket 220H, type I power socket 2201, type J power socket 220J, type K power socket 220K, type L power socket 220CL, etc., or universal power sockets, such as type A and type C universal socket 220M, multinational universal sockets 220N and 2200, can be applied to power sockets of various specifications. However, the present disclosure is not limited thereto.

Please refer to FIG. 19, which is a top view of a female interface 22 of the replaceable socket device 10 according to one embodiment of the present disclosure. The female interface 22 can also be a universal serial bus (USB) socket 222 to supply power to USB 2.0, USB 2.0 Standard A, USB 2.0 Type C, USB 3.0, USB 3.1, etc., and other electronic devices suitable for USB, and the female interface 22 can also be a 12V cigarette lighter socket 228. In addition, the replaceable socket device 10 may also have the function of power line communication to process network data and transmit and receive signals from other power line communication devices, electronic devices, the internet, etc. Therefore, the female interface 22 can also be a network socket 224 of RJ45 and other specifications. In this way, the replaceable socket device of the present disclosure can provide network signals to electronic devices while providing power supply. In addition to providing power and network signals, the adapting element 20 can also be a light emitting diode (LED) lamp 226, which can be used for lighting or as an indicator, such as displaying the load on the replaceable socket device 10, 10′, 10″, 10′″ in different LED colors, or displaying the online status of the network with long light or flashing. It should be noted that, the present disclosure is not limited to the example of the female interface 22 described above.

To sum up, the replaceable socket device 10, 10′, 10″, 10′″ can replace the adapting element 20 according to the requirement, or change the installation direction according to the use situation. In addition, the adapter 30 can also have different shapes for a user to choose from. The detachable adapter cable of the cable interface 32 can also be pulled out when not in use, which facilitates the overall storage of the replaceable socket device 10, 10′, 10″, 10′″ and reduces the occupation of space. Furthermore, due to the assemblies being modular, the user can select only the needed parts or choose to purchase only the damaged part, so that the cost can be reduced during manufacturing, and the user can also reduce the cost during purchase. In addition, through the first fool-proofing structure 210 and the second fool-proofing structure 330, the adapting element 20 can be limited to be installed on the adapter 30 only in the first installation direction or the second installation direction, and the user can directly see how the adapting element 20 should be installed visually, so as to avoid the user's wrong insertion when using the replaceable socket device 10, 10′, 10″, 10′″, and reduce the risk of short circuit or electric leakage. Therefore, the replaceable socket device 10, 10′, 10′, 10″ and adapter 30 of the present disclosure have the advantages of power safety, beauty, space-saving and cost-effectiveness.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

What is claimed is:

1. A replaceable socket device, comprising:
at least one adapting element, each of which comprising:
a first polarity terminal having a first polarity;
a second polarity terminal having a second polarity; and
a third polarity terminal having a third polarity; and
an adapter, comprising:
at least one adapter interface, engaging with the at least one adapting element, and each of the at least one adapter interface comprising a first polarity interface, a second polarity interface, and a third polarity interface;
a first polarity adapting member, electrically connected to the first polarity interface;
a second polarity adapting member, electrically connected to the second polarity interface; and
a third polarity adapting member, electrically connected to the third polarity interface;
wherein when the at least one adapting element and the at least one adapter interface are engaged with each other, the first polarity terminal is electrically connected to the at least one first polarity interface, the second polarity terminal is electrically connected to the at least one second polarity interface, and the third polarity terminal is electrically connected to the third polarity interface.

2. The replaceable socket device as claimed in claim 1, wherein the first polarity interface and the second polarity interface are disposed diagonally to each other.

3. The replaceable socket device as claimed in claim 1, wherein the first polarity interface and the second polarity interface are disposed in a cross shape with each other.

4. The replaceable socket device as claimed in claim 1, wherein the adapting element further comprises a first fool-proofing structure.

5. The replaceable socket device as claimed in claim 4, wherein the adapter further comprises a second fool-proofing structure that is disposed in the adapter interface and adapted to the first fool-proofing structure.

6. The replaceable socket device as claimed in claim 5, wherein the first fool-proofing structure is a groove, and the second fool-proofing structure is a protrusion structure adapted to the groove.

7. The replaceable socket device as claimed in claim 5, wherein the first fool-proofing structure is a protrusion structure, and the second fool-proofing structure is a groove adapted to the protrusion structure.

8. The replaceable socket device as claimed in claim 5, wherein the first fool-proofing structure is a lead angle, and the a second fool-proofing structure is a concave structure adapted to the lead angle.

9. The replaceable socket device as claimed in claim 5, wherein the first fool-proofing structure is a columnar structure, and the second fool-proofing structure is a containing structure adapted to the columnar structure.

10. The replaceable socket device as claimed in claim 5, wherein the first fool-proofing structure is a containing structure, and the second fool-proofing structure is a columnar structure adapted to the containing structure.

11. The replaceable socket device as claimed in claim 5, wherein a size of the first polarity terminal is larger than a size of the second polarity terminal; the first polarity terminal is used as the first fool-proofing structure, and the second fool-proofing structure is a containing structure adapted to the first polarity terminal.

12. The replaceable socket device as claimed in claim 1, wherein the first polarity terminal further comprises a sleeve structure, a part of which is disposed on the first polarity terminal; the first polarity terminal is used as the first fool-proofing structure, and the second fool-proofing structure is a containing structure adapted to the first polarity terminal.

13. An adapter adapted to at least one replaceable adapting element, comprising:
at least one adapter interface, engaging with the at least one adapting element, and each of the at least one adapter interface comprising a first polarity interface, a second polarity interface, and a third polarity interface;
a first polarity adapting member, electrically connected to the first polarity interface;
a second polarity adapting member, electrically connected to the second polarity interface; and
a third polarity adapting member, electrically connected to the third polarity interface;
wherein when the at least one adapting element and the at least one adapter interface are engaged with each other, the at least one adapting element is electrically connected to the at least one adapter interface.

14. The adapter as claimed in claim 13, wherein the first polarity interface and the second polarity interface are disposed diagonally to each other.

15. The adapter as claimed in claim 13, wherein the first polarity interface and the second polarity interface are disposed in a cross shape with each other.
